(19) United States
(12) Patent Application Publication
(10) Pub. No.: US 2025/0247577 A1
(43) Pub. Date: Jul. 31, 2025

(54) SYNCHRONIZED DISPLAY OF CONTENT ON MULTIPLE ELECTRONIC DEVICES

(71) Applicant: Apple Inc., Cupertino, CA (US)

(72) Inventors: Michelle CHUA, Seattle, WA (US); Danvin RUANGCHAN, San Jose, CA (US); David A. LIPTON, San Mateo, CA (US); Joshua CHOI, Alameda, CA (US)

(21) Appl. No.: 19/033,259

(22) Filed: Jan. 21, 2025

Related U.S. Application Data
(60) Provisional application No. 63/625,526, filed on Jan. 26, 2024.

(51) Int. Cl. H04N 21/43; G06F 3/01; G06T 19/00; H04N 21/44

(52) U.S. Cl. CPC H04N 21/43076; G06F 3/013; G06T 19/006; H04N 21/44008

(57) ABSTRACT

Some examples of the disclosure are directed to systems and methods for synchronizing display of content among multiple devices. In some examples, a first electronic device detects a second display in communication with a second electronic device at a first location in a physical environment of the first electronic device. In some examples, in response to detecting the second display, in accordance with a determination that one or more criteria are satisfied, the first electronic device displays a first object at a first location in a computer-generated environment that corresponds to the first location in the physical environment, wherein the first object includes first content. In some examples, in accordance with a determination that the one or more criteria are not satisfied, the first electronic device forgoes display of the first object at the first location in the computer-generated environment.

### CROSS REFERENCE TO RELATED APPLICATIONS

This application claims the benefit of U.S. Provisional Application No. 63/625,526, filed Jan. 26, 2024, the entire disclosure of which is herein incorporated by reference for all purposes.

### FIELD OF THE DISCLOSURE

This relates generally to systems and methods of synchronizing display of content, such as video content, between electronic devices.

### BACKGROUND OF THE DISCLOSURE

Some computer graphical environments provide two-dimensional and/or three-dimensional environments where at least some objects displayed for a user's viewing are virtual and generated by a computer. In some examples, an electronic device displays a virtual user interface in a computer-generated environment that is configured to playback content, such as video content. In some examples, the same content is also configured to be displayed on a two-dimensional display of a second electronic device, different from the electronic device, which is visible in the computer-generated environment.

### SUMMARY OF THE DISCLOSURE

Some examples of the disclosure are directed to systems and methods for synchronizing display of content among multiple devices. In some examples, a method is performed at a first electronic device in communication with one or more displays, one or more input devices, and one or more cameras. In some examples, the first electronic device detects, via the one or more cameras, a second display, different from the one or more displays, in communication with a second electronic device, different from the first electronic device, at a first location in a physical environment of the first electronic device. In some examples, in response to detecting the second display, in accordance with a determination that one or more criteria are satisfied, the first electronic device displays, via the one or more displays, a first object at a first location in a computer-generated environment that corresponds to the first location in the physical environment, wherein the first object includes first content. In some examples, in accordance with a determination that the one or more criteria are not satisfied, the first electronic device forgoes display of the first object at the first location in the computer-generated environment.

In some examples, the one or more criteria include a criterion that is satisfied in accordance with a determination that the second display is displaying the first content. In some examples, the one or more criteria include a criterion that is satisfied in accordance with a determination that the first content is content of a first type and that is not satisfied in accordance with a determination that the first content is content of a second type, different from the first type. In some examples, the one or more criteria include a criterion that is satisfied in accordance with a determination that gaze of a user of the first electronic device is directed to the second display when the second display is detected. In some examples, the one or more criteria include a criterion that is satisfied in accordance with a determination that, based on one or more physical properties of the second display, content displayed via the second display is visually detectable via the one or more cameras.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIGS. 3A-3J illustrate examples of an electronic device displaying a user interface including content in a computer-generated environment in response to detecting display of the content in a physical environment according to some examples of the disclosure.

FIGS. 4A-4C illustrate examples of an electronic device causing display of content at a second electronic device in a physical environment according to some examples of the disclosure.

FIG. 5 is a flow diagram illustrating an example process for displaying a user interface including content in a computer-generated environment in response to detecting display of the content in a physical environment according to some examples of the disclosure.

### DETAILED DESCRIPTION

Some examples of the disclosure are directed to systems and methods for synchronizing display of content among multiple devices. In some examples, a method is performed at a first electronic device in communication with one or more displays, one or more input devices, and one or more cameras. In some examples, the first electronic device detects, via the one or more cameras, a second display, different from the one or more displays, in communication with a second electronic device, different from the first electronic device, at a first location in a physical environment of the first electronic device. In some examples, in response to detecting the second display, in accordance with a determination that one or more criteria are satisfied, the first electronic device displays, via the one or more displays, a first object at a first location in a computer-generated environment that corresponds to the first location in the physical environment, wherein the first object includes first content. In some examples, in accordance with a determination that the one or more criteria are not satisfied, the first electronic device forgoes display of the first object at the first location in the computer-generated environment.

In some examples, the one or more criteria include a criterion that is satisfied in accordance with a determination that the second display is displaying the first content. In some examples, the one or more criteria include a criterion that is satisfied in accordance with a determination that the first content is content of a first type and that is not satisfied in accordance with a determination that the first content is content of a second type, different from the first type. In some examples, the one or more criteria include a criterion that is satisfied in accordance with a determination that gaze of a user of the first electronic device is directed to the second display when the second display is detected. In some examples, the one or more criteria include a criterion that is satisfied in accordance with a determination that, based on one or more physical properties of the second display, content displayed via the second display is visually detectable via the one or more cameras.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

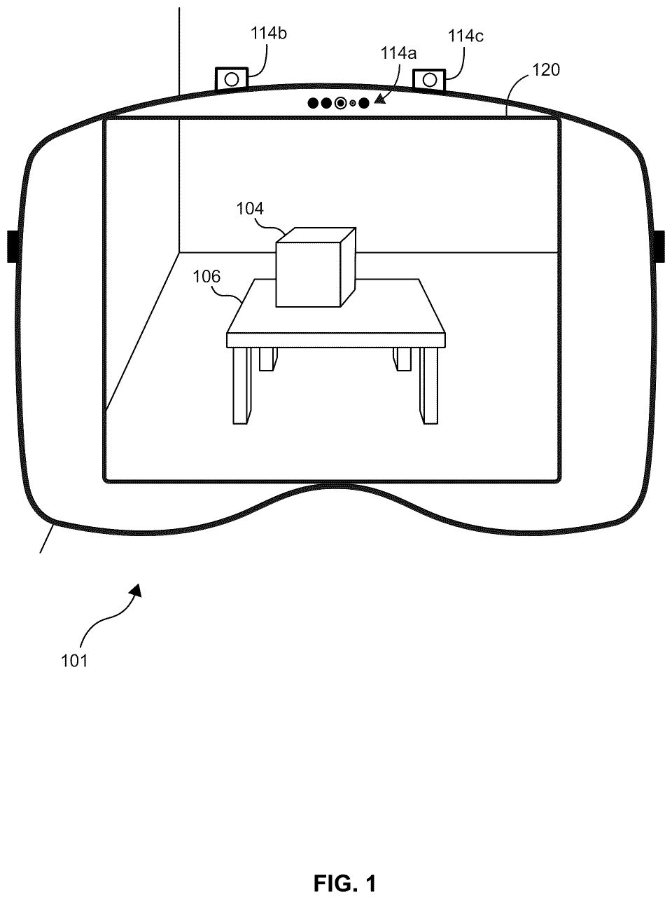

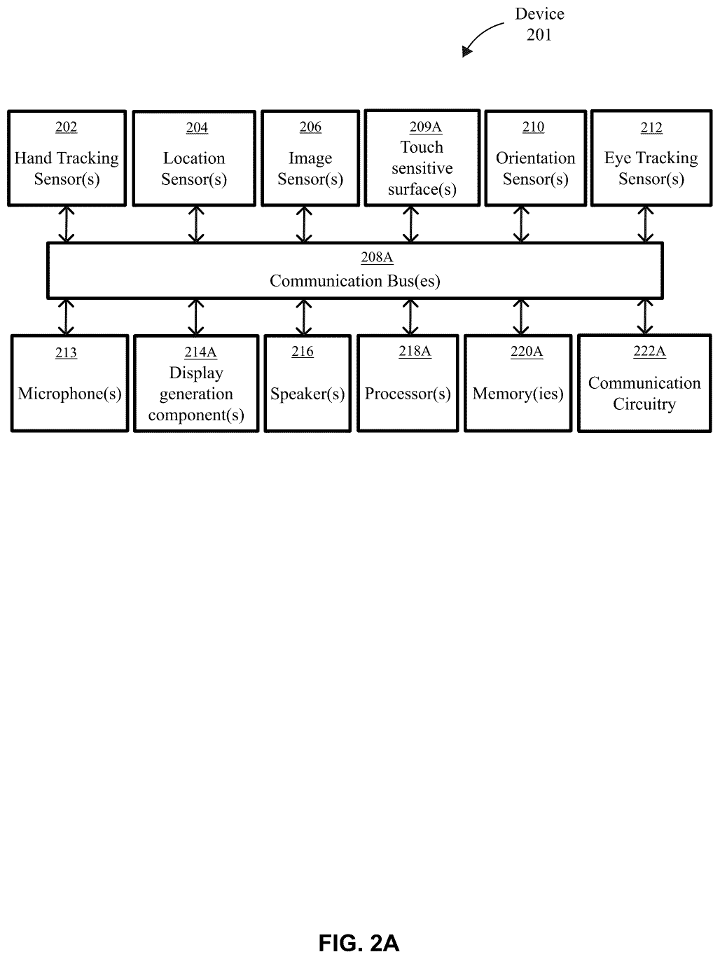

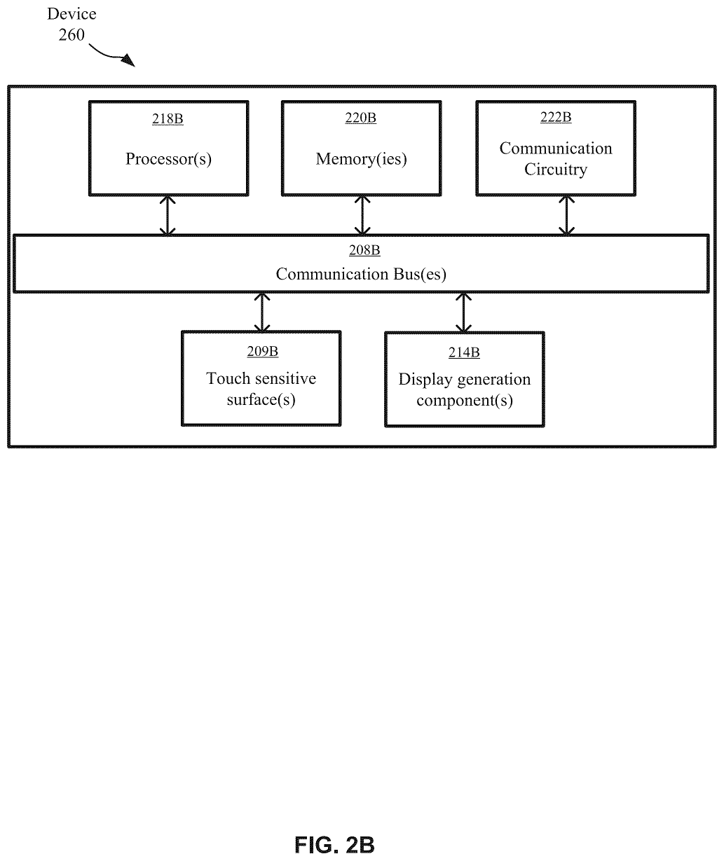

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2A). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices 201 and 260 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2A, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209A, one or more motion and/or orientation sensors 210, one or more eye tracking sensors 212, one or more microphones 213 or other audio sensors, one or more body tracking sensors (e.g., torso and/or head tracking sensors), one or more display generation components 214A, optionally corresponding to display 120 in FIG. 1, one or more speakers 216, one or more processors 218A, one or more memories 220A, and/or communication circuitry 222A. One or more communication buses 208A are optionally used for communication between the above-mentioned components of electronic device 201. Additionally, as shown in FIG. 2B, the electronic device 260 optionally includes one or more touch-sensitive surfaces 209B, one or more display generation components 214B, one or more processors 218B, one or more memories 220B, and/or communication circuitry 222B. One or more communication buses 208B are optionally used for communication between the above-mentioned components of electronic device 260. The electronic devices 201 and 260 are optionally configured to communicate via a wired or wireless connection (e.g., via communication circuitry 222A, 222B) between the two electronic devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 201 and 260 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with each of electronic devices 201 and 260 or external to each of electronic devices 201 and 260 that is in communication with each of electronic devices 201 and 260).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214A in the real-world environment. For example, electronic device 201 uses image sensor(s) 206 to track the position and orientation of display generation component(s) 214A relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214A. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214A. For example, electronic device 201 uses orientation sensor(s) 210 to track changes in the position and/or orientation of electronic device 201 and/or display generation component(s) 214A, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214A, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214A. In some examples, hand tracking sensor(s) 202 and/or eye tracking sensor(s) 212 are implemented together with the display generation component(s) 214A. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body part (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configurations of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards examples of selective display of one or more user interfaces in a computer-generated environment, where the one or more user interfaces include content that corresponds to content displayed on a physical display within a physical environment of the computer-generated environment.

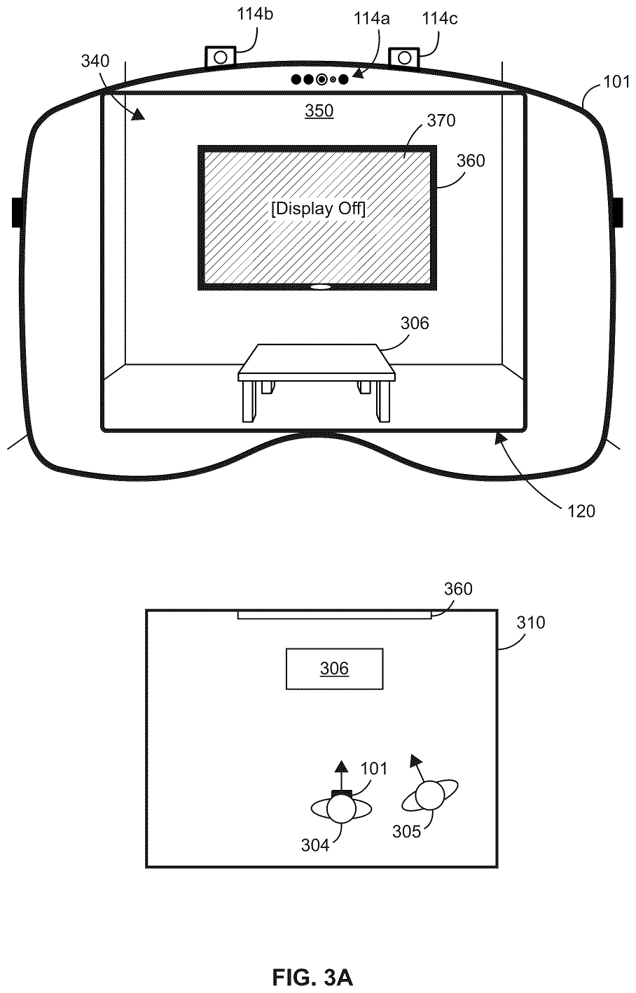

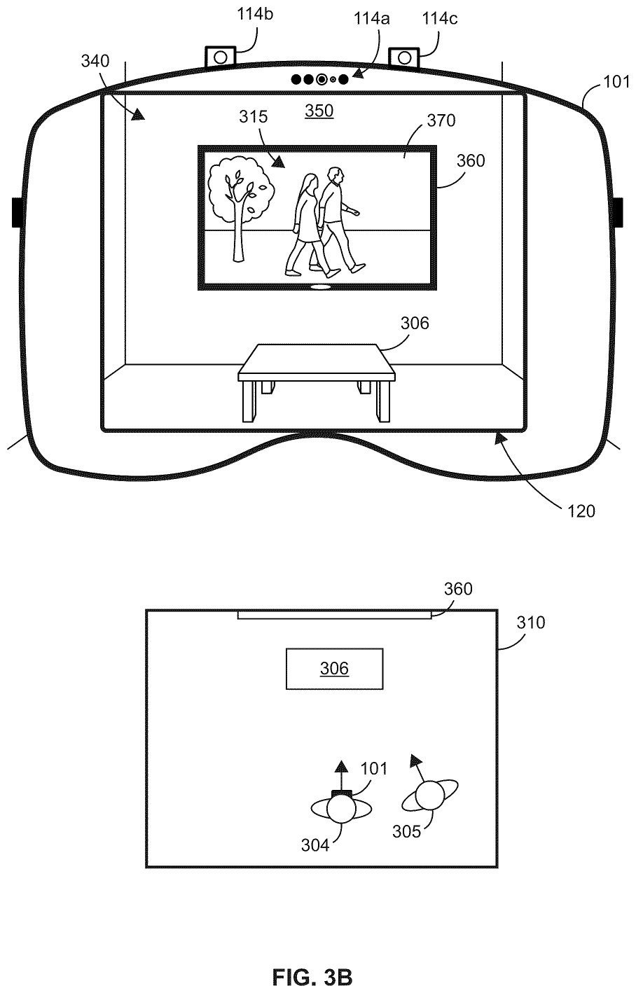

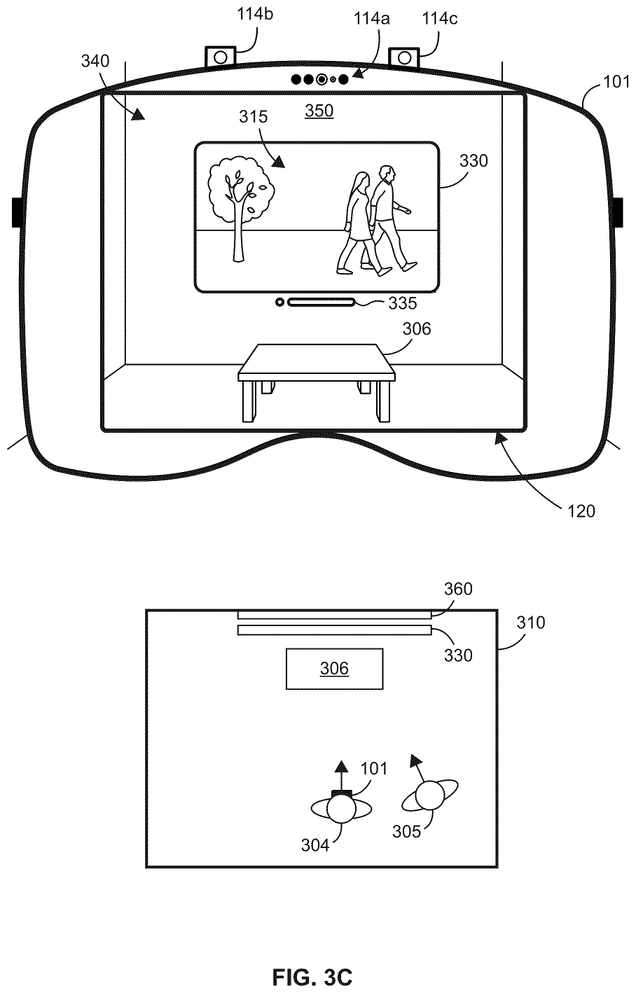

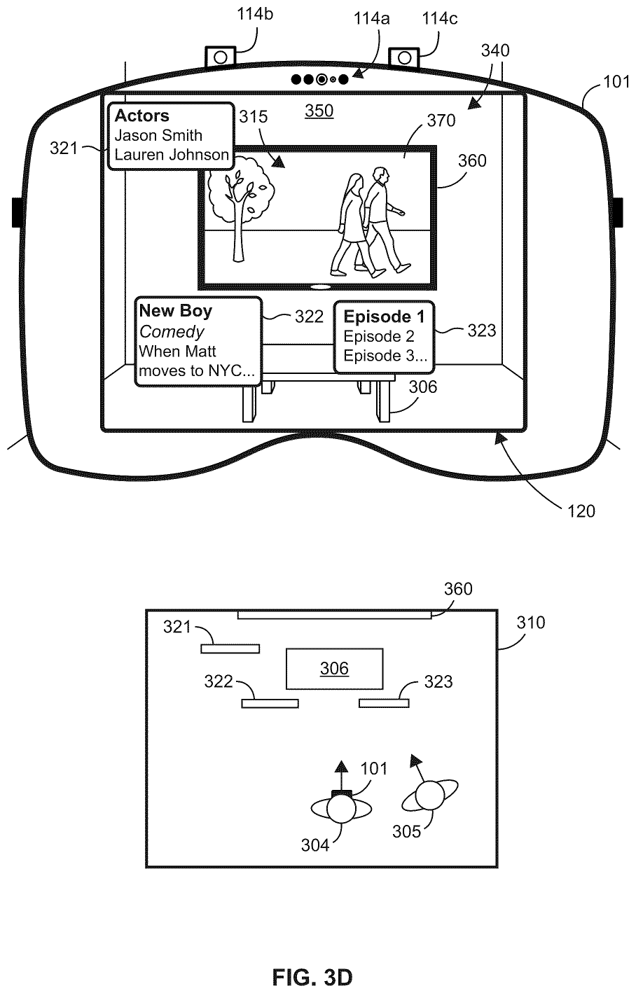

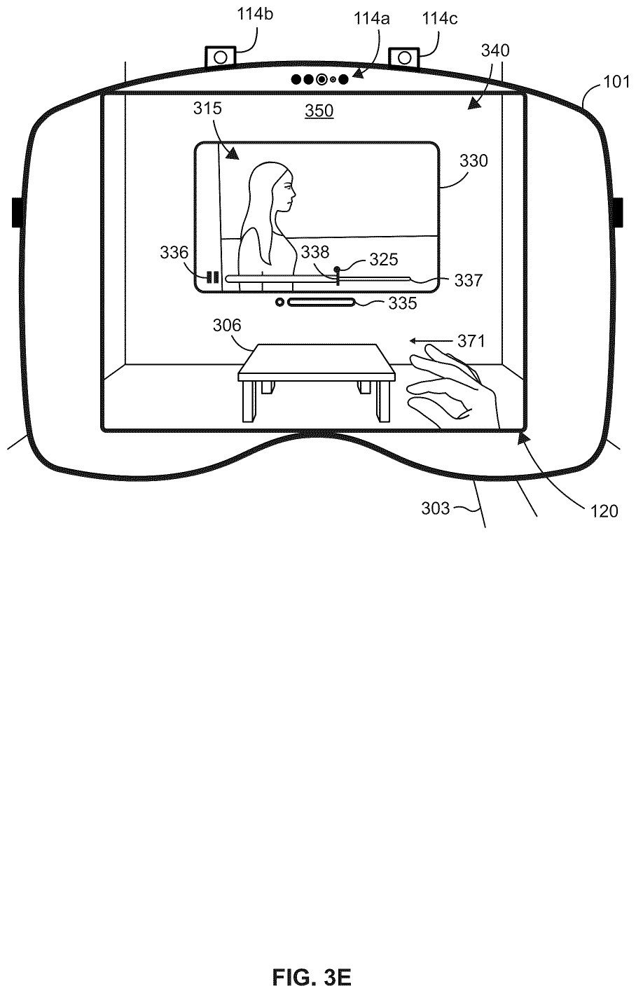

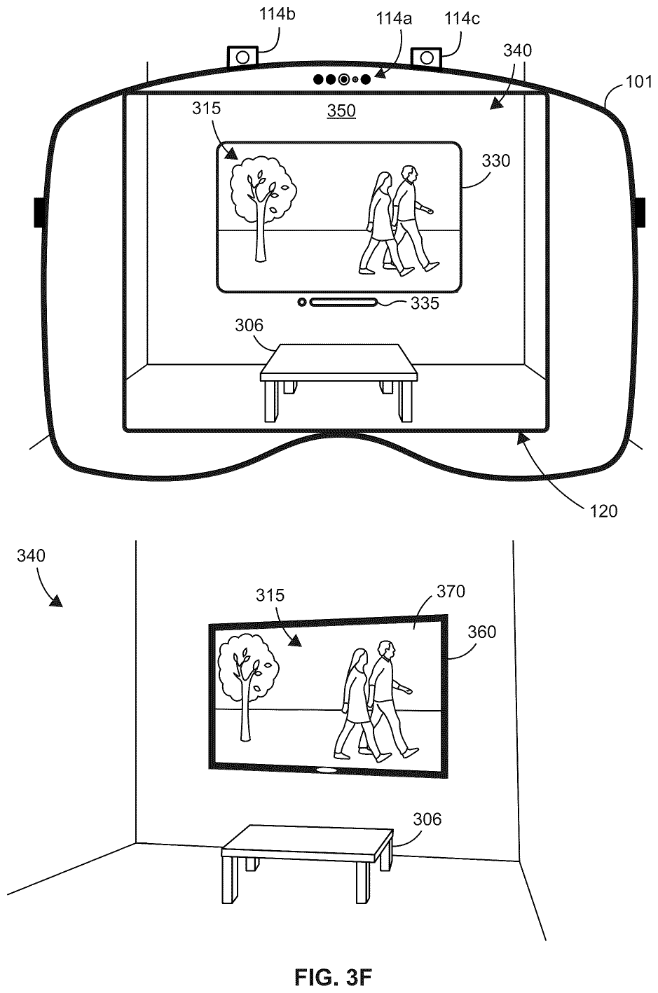

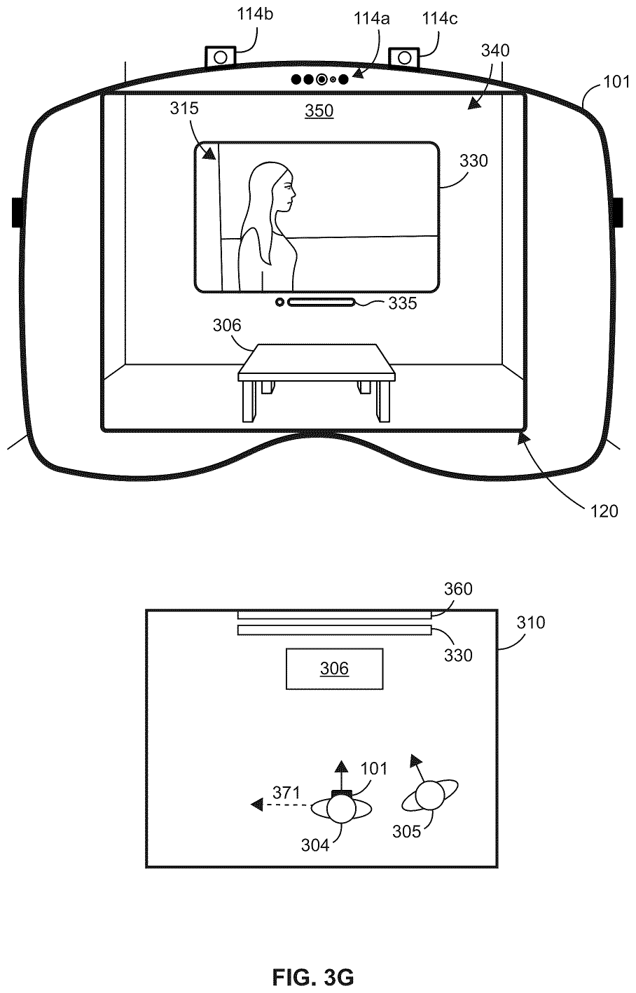

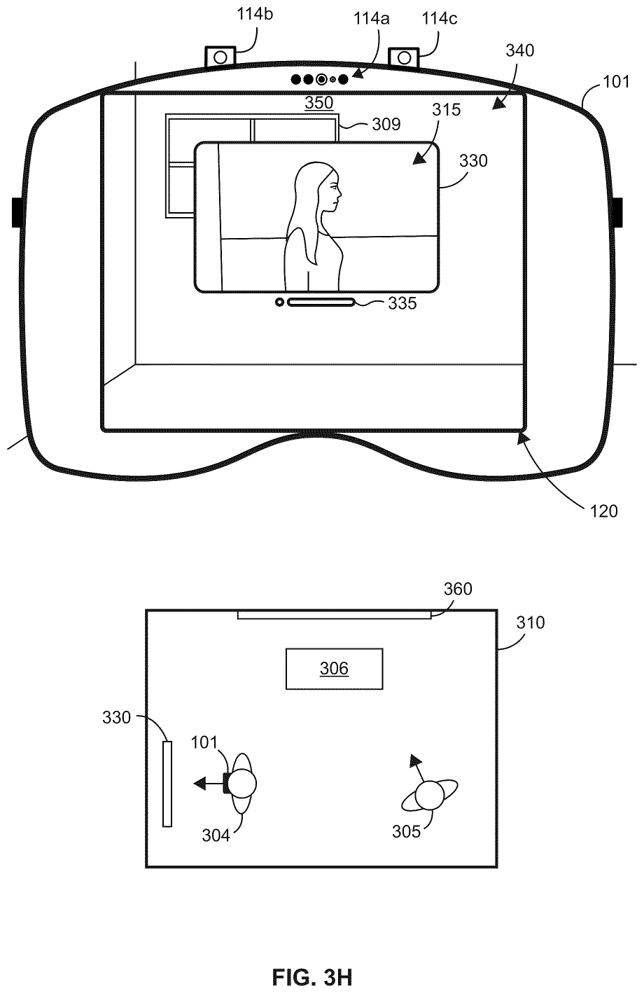

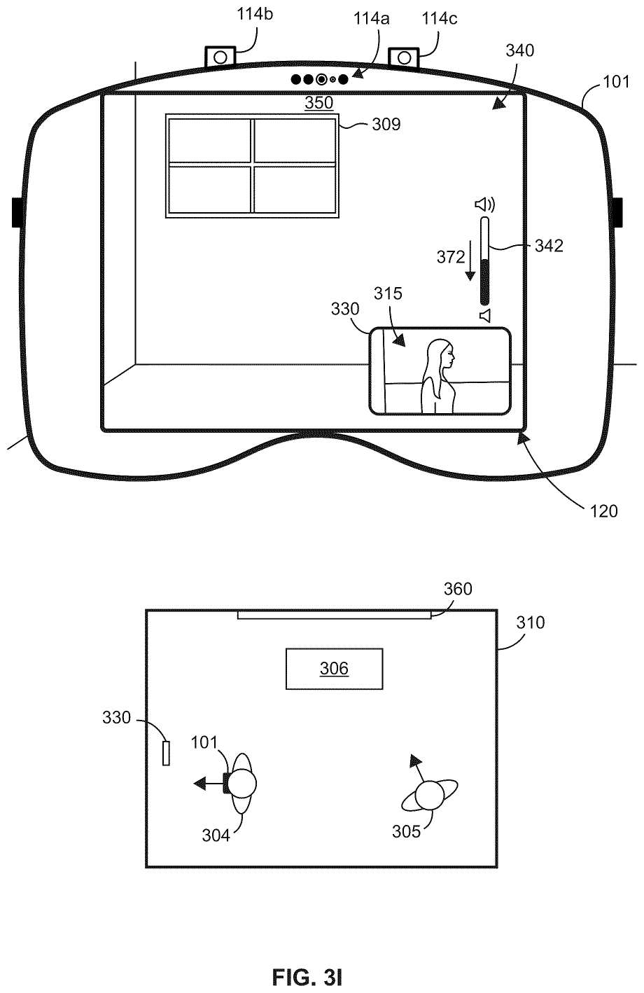

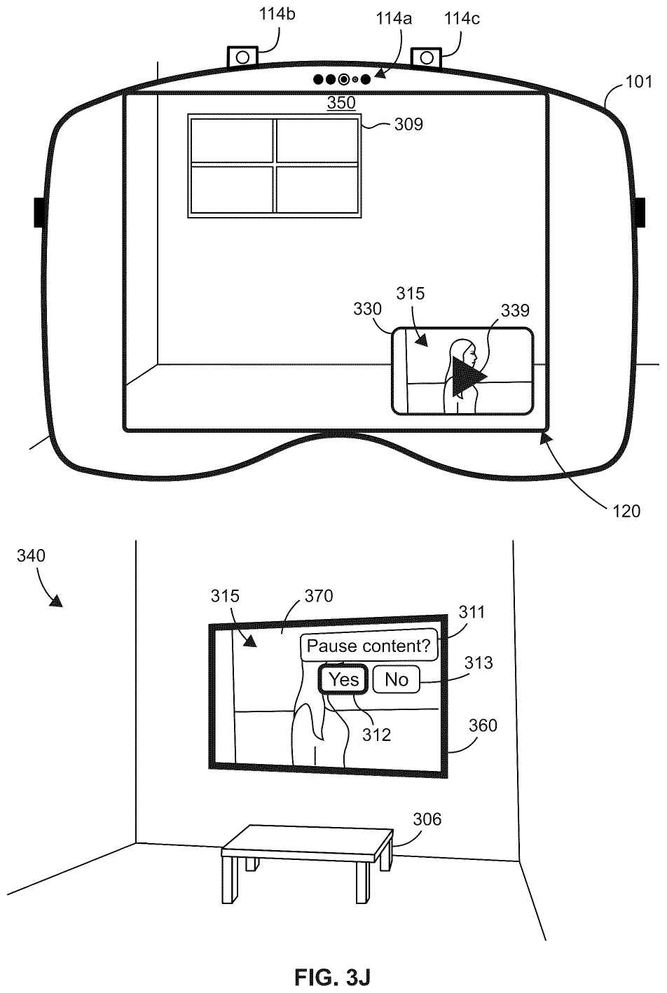

FIGS. 3A-3J illustrate examples of an electronic device displaying a user interface including content in a computer-generated environment in response to detecting display of the content in a physical environment according to some examples of the disclosure. The electronic device 101 may correspond to or may be similar to electronic device 101 or 201 discussed above, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, or displays formed as lenses designed to be placed on a person's eyes (e.g., similar to contact lenses). In the example of FIGS. 3A-3J, a user is optionally wearing the electronic device 101, such that three-dimensional environment 350 (e.g., a computer-generated environment) can be defined by X, Y and Z axes as viewed from a perspective of the electronic device (e.g., a viewpoint associated with the user of the electronic device 101). Accordingly, as used herein, the electronic device 101 is configured to be movable with six degrees of freedom based on the movement of the user (e.g., the head of the user), such that the electronic device 101 may be moved in the roll direction, the pitch direction, and/or the yaw direction.

As shown in FIG. 3A, the electronic device 101 may be positioned in a physical environment (e.g., an outdoors environment) that includes a plurality of real-world objects. For example, in FIG. 3A, the electronic device 101 may be positioned in a physical environment 340 that includes a television 360 having display 370 that is visible in the field of view of the electronic device 101. In some examples, the television 360 has one or more characteristics of the electronic device 260 in FIG. 2B. In some examples, the television 360 is configured to communicate with the electronic device 101 (e.g., via a wired or wireless communication link). Additionally, in some examples, the physical environment 340 includes a table 306 that is currently visible in the field of view of the electronic device 101. Accordingly, in some examples, the three-dimensional environment 350 presented using the electronic device 101 optionally includes captured portions of the physical environment (e.g., the room in which the user of the electronic device 101 is located) surrounding the electronic device 101, such as representations of the television 360, the table 306, and/or the floor and walls of the physical environment 340. In some examples, the representations can include portions of the physical environment viewed through a transparent or translucent display of electronic device 101.

As shown in overhead view 310 in FIG. 3A, the user 304 of the electronic device 101 may be collocated in the physical environment 340 with a second user 305. In some examples, as illustrated in the overhead view 310, the second user 305 is optionally not using (e.g., wearing) an electronic device similar to the electronic device 101. For example, in FIG. 3A, the second user 305 is not wearing a head-mounted display like the user 304 is. Additionally, as shown in the overhead view 310, the user 304 and the second user 305 are facing toward the television 360 in the physical environment 340, as represented by the respective arrows extending from the users 304 and 305.

In some examples, the electronic device 101 facilitates a co-viewing experience of content that is being presented in the physical environment 340, such as content being displayed on the display 370 of the television 360. For example, as discussed herein, the electronic device 101 may be configured to present, in the three-dimensional environment 350, a virtual object (e.g., a virtual window) that includes the content displayed on the display 370 and/or that corresponds to or is otherwise associated with the content displayed on the display 370 in the physical environment 340. As illustrated in FIG. 3A, the television 360 is currently not displaying content on the display 370 (e.g., because the television 360 is currently powered off, is operating in a low power mode or sleep mode, or otherwise is not displaying content on the display 370). Accordingly, as discussed in more detail below, the electronic device 101 forgoes presenting a virtual object in the three-dimensional environment 350 that is displaying content (e.g., because no content is currently being displayed in the physical environment 340).

From FIGS. 3A to 3B, the television 360 receives a sequence of one or more inputs that causes the television 360 to initiate display of content on the display 370. For example, as shown in FIG. 3B, the television 360 is displaying video content 315 (e.g., an episode of a television (TV) show, a movie, a short film, or other video content) that is accessible on the television 360 (e.g., via an application running on the television 360, via a secondary electronic device in communication with the television 360, such as a cable box, a digital media player, console, or other set-top box, etc.) on the display 370. In some examples, the sequence of one or more inputs includes an input to power on and/or activate (e.g., awaken) the television 360 and/or the display 370, one or more inputs to navigate to and/or through an application or other video delivery service (e.g., cable television), and/or an input selecting a particular content item (e.g., movie, TV episode, channel, clip, etc.) for playback on the display 370. In some examples, as shown in FIG. 3B, when the television 360 initiates playback of the video content 315, the video content 315 is included in the three-dimensional environment 350 (e.g., via representations of the physical environment 340 or passthrough of the physical environment 340).

In FIG. 3B, the electronic device 101 visually detects the video content 315 being played back (e.g., displayed) on the display 370 of the television 360. For example, the electronic device 101 scans and/or captures one or more images (e.g., using one or more cameras, such as external image sensors 114b and 114c) of the video content 315 being displayed in the physical environment 340. As mentioned above, in some examples, the electronic device 101 may be configured to present one or more virtual objects in the three-dimensional environment 350 that include content corresponding to or otherwise associated with the video content 315 that is detected by the electronic device 301. Particularly, in some examples, the electronic device 101 displays the one or more virtual objects in the three-dimensional environment 350 in accordance with a determination that one or more criteria are satisfied, as discussed below.

In some examples, satisfaction of the one or more criteria is based on detectability of the video content 315 being displayed in the physical environment 340. For example, one or more physical attributes of the television 360 and/or of the electronic device 101 may determine (e.g., enable or hinder) the ability of the one or more cameras of the electronic device 101 to visually detect (e.g., scan and/or capture images of) the video content 315 displayed on the display 370, such as an angle of the television 360 relative to the electronic device 101, a location of the television 360 in the physical environment 340 relative to the electronic device 101 (e.g., and/or the television 360 being within a field of view of the electronic device 101), a size of the display 370 of the television 360, and/or an orientation of the television 360 relative to the electronic device 101 (e.g., the video content 315 being aligned to a horizon of the field of view (e.g., a horizontal line extending through a center of the field of view) of the three-dimensional environment 350). As an example, if the display 370 of the television 360 is oriented at an extreme angle relative to the viewpoint of the electronic device 101 (e.g., is oriented at greater than 45, 50, 55, 70, 80, 90, etc. degrees relative to the viewpoint) and/or is below a threshold size relative to the viewpoint of the electronic device 101, the video content 315 displayed on the display 370 may be undetectable by the one or more cameras of the electronic device 101.

In some examples, satisfaction of the one or more criteria is based on a communication between the electronic device 101 and the television 360. For example, the one or more criteria are satisfied if the electronic device 101 is in communication with and/or is configured to communicate with (e.g., via a wired or wireless communication link) the television 360 (e.g., or a secondary electronic device in communication with the television 360, such as a cable box, a digital media player, console, or other set-top box). Additionally or alternatively, in some examples, the one or more criteria are satisfied if the television 360 (e.g., or a secondary electronic device in communication with the television 360) and the electronic device 101 are associated with a same user account (e.g., having one or more authorized users), and the user is signed into the user account on both devices. In some examples, satisfaction of the one or more criteria is based on access to the video content 315 being displayed on the display 370. For example, the access to the video content 315 may be based on the association of the electronic device 101 with the same user account as the television 360, as similarly discussed above. In some examples, access to the video content 315 is based on one or more device permissions (e.g., user settings). For example, the electronic device 101 is associated with the same user account as the television 360, but the electronic device 101 specifically is not authorized to display the video content 315 (e.g., according to parental restrictions imposed by the electronic device 101). In some examples, the access to the video content 315 is based on availability of the video content 315 on the electronic device 101. For example, the video content 315 may not be downloaded on and/or stored in a media library or other repository of the electronic device 101, or the electronic device 101 does not currently have access to the video content 315 because an application via which the video content 315 is available is not currently running on or operable on the electronic device 101 (e.g., due to Wi-Fi, data, or other wireless connectivity issues). In some examples, access to the video content 315 is based on privacy of the content being displayed on the television 360. For example, the one or more criteria are satisfied if the content being displayed on the display 370 is publicly available content (e.g., available freely via the internet or via a paid subscription) via an application, website, etc. Accordingly, if the video content 315 is private content, such as a video recording or image captured by a particular electronic device or a file stored on a particular electronic device (e.g., such as a personal device of the second user 305) that is not accessible via an application, website, etc., the one or more criteria are not satisfied. As another example, if the video content 315 corresponds to a digital video call with one or more other users (e.g., including the second user 305) that does not include the user of the electronic device 101, the one or more criteria are not satisfied (e.g., because the electronic device 101 is not actually in communication with the other device(s) for the call).

In some examples, the satisfaction of the one or more criteria is based on content type. For example, the electronic device 101 may be configured to render (e.g., generate and display) particular types of content in the three-dimensional environment 350 but not others. For example, the one or more criteria are satisfied if the content being displayed on the display 370 is a motion picture (e.g., video content) that is produced and distributed for mass consumption (e.g., by a particular media provider, such as a production company, network, filmmaker, etc.). On the other hand, in some instances, the one or more criteria are not satisfied if the content corresponds to a still image (e.g., a single photograph, screenshot, or other image file). As another example, the one or more criteria are satisfied if the content corresponds to a user interface of particular applications (e.g., internet browsing applications, video game applications, music player applications, etc.), but not if the content corresponds to a user interface of other applications (e.g., note taking applications, document viewing applications, messaging applications (e.g., email, text, online messaging, etc.), etc.).

In some examples, the satisfaction of the one or more criteria is based on identification of the video content 315. For example, identification of the video content 315 controls whether the electronic device 101 is able to generate and display the same content in the three-dimensional environment 350. Accordingly, the electronic device 101 is optionally unable to display a virtual object that includes the video content 315 (or content associated with the video content 315) if the electronic device 101 is unable to identify the particular video content 315 and/or locate a source for playing back the video content 315. In some examples, identification of the video content 315 is based on one or more image processing techniques, such as computer vision, optical character recognition, object recognition, among other possibilities. In some such examples, if such image processing techniques are unable to yield a result that matches the video content 315 (e.g., above some threshold confidence level, such as 85, 88, 90, 95, etc. percent), then the one or more criteria are not satisfied. Additionally or alternatively, in some examples, the identification of the video content 315 is based on content identification data received from the television 360 (e.g., and/or a secondary electronic device in communication with the television 360, as similarly discussed above). For example, the electronic device 101 receives the content identification data from the television 360 and locates a source for playing back the video content 315 using the content identification data.

In some examples, the electronic device 101 determines that the one or more criteria are satisfied based on detection of user attention and/or interest in the video content 315. For example, in FIG. 3B, the electronic device 101 determines that the one or more criteria are satisfied in accordance with a determination that a gaze of the user is directed to the video content 315 displayed on the display 370. Similarly, the electronic device 101 determines that the one or more criteria are satisfied in accordance with a determination that the video content 315 remains visible and detectable in the field of view of the electronic device 101 for at least a threshold amount of time (e.g., 1, 2, 3, 4, 5, 10, 15, 30, 60, 90, etc. seconds). In some examples, the one or more criteria are satisfied if the gaze of the user is directed to the video content 315 in the physical environment for at least the threshold amount of time. In some examples, the electronic device 101 determines that the one or more criteria are satisfied in response to detecting alternate forms of user input that indicate user interest in the video content 315, such as a pointing gesture, clapping gesture, snapping gesture, or other gesture performed by one or more hands of the user 304 and directed to the video content 315. In some examples, the user input includes verbal input detected via a microphone of the electronic device 101 that indicates user interest (e.g., the electronic device 1010 detects the user 304 speak the words “I like this movie” or “I've been wanting to see this show,” among other possibilities).

In FIG. 3B, in response to visually detecting the video content 315 in the physical environment 340, the electronic device 301 determines that the one or more criteria discussed above are satisfied. It should be understood that, in the example of FIG. 3B, the electronic device 301 determines that the one or more criteria are satisfied according to the satisfaction of any one or combination of the criteria discussed above.

In some examples, as shown in FIG. 3C, in accordance with the determination that the one or more criteria are satisfied, the electronic device 101 displays virtual window 330 in the three-dimensional environment 350. Additionally, as shown in FIG. 3C, the virtual window 330 is optionally displaying the video content 315 discussed above and concurrently being displayed on the display 370 of the television 360 in the physical environment 340. In some examples, the virtual window 330 corresponds to and/or includes a virtual playback user interface that is configured to playback virtual media (e.g., movies, television shows, video clips, etc.). In some examples, the virtual window 330 is associated with a respective application running on the electronic device 101, such as a media player application. As shown in FIG. 3C, in some examples, the virtual window 330 is displayed with a grabber of handlebar 335 that is selectable to initiate movement of the virtual window 330 (and thus the video content 315) within the three-dimensional environment 350.

As shown in the overhead view 310 in FIG. 3C, when the electronic device 101 displays the virtual window 330 in the three-dimensional environment 350, the virtual window 330 is displayed at a location in the three-dimensional environment 350 that corresponds to and/or overlaps with the location of the display 370 of the television 360 in the physical environment 340. Accordingly, as shown in FIG. 3C, when the virtual window 330 is displayed in the three-dimensional environment 350, the virtual window 330 obscures and/or is overlaid on the display 370 relative to the viewpoint of the user 304 (e.g., the virtual window 330 is positioned in front of the television 360 from the viewpoint of the user 304), such that the video content 315 that is displayed on the display 370 is no longer visible in the three-dimensional environment 350. In some examples, a size of the virtual window 330 corresponds to (e.g., is the same as) a size of the display 370 of the television 360 in the physical environment 340, as illustrated in the overhead view 310. In some examples, the size of the virtual window 330 is larger than the size of the display 370 in the physical environment 340. In some examples, the virtual window 330 is displayed as a world locked object in the three-dimensional environment 350. As indicated in the overhead view 310, because the virtual window 330 is displayed only by the electronic device 101, the video content 315 that is displayed on the display 370 of the television 360 remains visible to the second user 305 in the physical environment 340.

In some examples, the electronic device 101 is displaying the video content 315 using a source (e.g., a media provider) that is the same as a source of the video content 315 that is being displayed by the television 360 on the display 370. For example, the electronic device 101 and the television 360 (e.g., or a secondary electronic device in communication with the television 360, as similarly discussed above) are displaying the video content 315 using streaming and/or broadcasting data provided by the same media provider and/or application. In some examples, the electronic device 101 is displaying the video content 315 using a source (e.g., a media provider) that is different from a source of the video content 315 that is being displayed by the television 360 on the display 370. For example, the electronic device 101 and the television 360 (e.g., or a secondary electronic device in communication with the television 360, as similarly discussed above) are displaying the video content 315 using streaming and/or broadcasting data provided by different media providers and/or different applications.

In some examples, the display of the video content 315 in the virtual window 330 is synchronized with the display of the video content 315 on the display 370 of the television 360. For example, the video content 315 is displayed in the virtual window 330 at a same playback position as the video content 315 that is displayed on the display 370 of the television 360 in the physical environment 340. Additionally, in some examples, the video content 315 is displayed at a same playback speed as the video content 315 that is displayed on the display 370 of the television 360 in the physical environment 340. In some examples, output of audio corresponding to the video content 315 is therefore synchronized between the electronic device 101 and the television 360. For example, the audio of the video content 315 output by the electronic device 101 (e.g., via one or more speakers in communication with the electronic device 101) corresponds to the audio of the video content 315 output by the television 360 (e.g., via one or more speakers in communication with the television 360). Similarly, in some examples, the audio corresponding to the video content 315 is output in a same format by the devices (e.g., the electronic device 101 and the television 360). For example, the audio may be presented as spatial audio, stereo audio, etc. at both the electronic device 101 and the television 360 (e.g., the audio may be spatialized relative to the television 360 in the three-dimensional environment 350). It should be understood that, in some examples, one or more characteristics of the output of the audio corresponding to the video content 315 may be personalized and/or adjusted at each device by their respective users, such as a volume of the audio, the format of the audio, etc. Additionally, it should be understood that, in some examples, the electronic device 101 forgoes outputting audio corresponding to the video content 315 in accordance with a determination that the audio is alternatively being presented in a manner that sufficiently enables the user 304 to hear the audio. For example, the electronic device 101 forgoes outputting the audio corresponding to the video content 315 if the television 360 or the electronic device 101 is outputting the audio via extra-aural speakers or some other audio system, or if the audio is being outputted via open-back headphones (e.g., worn and/or used by the second user 305), as an example. Accordingly, the viewing experience of the video content 315 is synchronized and consistent for the user 304 and the second user 305 across the electronic device 101 and the television 360.

Accordingly, in some examples, one benefit of presenting the virtual window 330 that includes the video content 315 in the manner discussed above is that image quality of the content, as viewed by the user 304 of the electronic device 101, may be improved compared to when the video content 315 is alternatively viewed via passthrough, as discussed below with reference to FIG. 3D, which improves experience. For example, as discussed below, presenting the video content 315 to the user 304 as a passthrough representation may introduce reductions in image quality due to the reliance of image capture by the one or more cameras of the electronic device 101.

Alternatively, in some examples, the electronic device 101 displays content that is supplemental to the video content 315 in the three-dimensional environment 350. For example, as shown in FIG. 3D, in addition to or rather than displaying the virtual window 330 that includes the video content 315, the electronic device 101 displays supplemental content in the three-dimensional environment 350 in response to detecting the video content 315 and in accordance with the determination that the one or more criteria discussed above are satisfied. As shown in FIG. 3D, the electronic device 101 displays one or more user interface elements that include information and/or other content that is associated with the video content 315 being displayed on the display 370 of the television 360. For example, as shown in FIG. 3D, the electronic device 101 is displaying a first user interface element 321 that includes information indicative of actors in the video content 315 (e.g., lead actors, actors currently in the scene, etc.), a second user interface element 322 that includes a description of the video content 315 (e.g., a name of the video content 315, a genre for the video content 315, and/or a synopsis or summary of the video content 315), and a third user interface element 323 that includes indications of a type of content of the video content 315 (e.g., episodic content). Accordingly, as illustrated in FIG. 3D, the user 304 of the electronic device 101 is able to view the video content 315 that is displayed on the display 370 (e.g., view a representation of the video content 315 or view the video content 315 in passthrough) while gaining additional insight into the video content 315 via the information presented in the one or more user interface elements in the three-dimensional environment 350, thereby improving the user's viewing experience.

In some examples, as shown in FIG. 3D, the one or more user interface elements are displayed relative to the display 370 of the television 360 in the three-dimensional environment 350. For example, the one or more user interface elements are displayed at locations in the three-dimensional environment 350 surrounding the television 360, such as in front of the television 360 relative to the viewpoint of the user 304, below the television 360 relative to the viewpoint of the user 304, to a side of the television 360 relative to the viewpoint, and/or above the television 360 relative to the viewpoint. In some examples, the first user interface element 321, the second user interface element 322, and the third user interface element 323 are displayed as world-locked objects in the three-dimensional environment 350.

As mentioned above, in some examples, while the video content 315 is displayed in the virtual window 330 in the three-dimensional environment 350, the electronic device 101 synchronizes the display and playback of the video content 315 with the display and playback of the video content 315 that is displayed on the display 370 of the television 360 in the physical environment 340. Accordingly, as discussed below, user input that is detected for adjusting playback of the video content 315 at one device optionally causes the playback of the video content 315 to be adjusted at both devices (e.g., the electronic device 101 and the television 360).

In FIG. 3E, while the electronic device 101 is displaying the virtual window 330 that includes the video content 315 in the three-dimensional environment 350, the electronic device 101 detects an input corresponding to a request to update a current playback position within the video content 315 (e.g., an input for scrubbing through the video content 315). For example, as shown in FIG. 3E, the electronic device 101 detects a pinch and drag gesture performed by hand 303 of the user 304 (e.g., in which an index finger and thumb of the hand 303 come together to make contact, followed by movement of the hand 303 in the direction of arrow 371), while gaze 325 of the user 304 is directed to scrubber bar 338 within playback timeline 337 in the virtual window 330. In other words, the input provided by the hand 303 corresponds to a request to rewind the video content 315 relative to the current playback position within the video content 315. In some examples, the input provided by the user 304 includes solely gaze-based interaction, a verbal command, selection of an affordance (e.g., selection of a rewind arrow or a fast forward arrow), etc. It should be understood that additional or alternative inputs may be detected for adjusting the playback of the video content 315 in the three-dimensional environment 350, such as selection of pause option 336 in the virtual window 330 that is selectable to pause playback of the video content 315. It should also be understood that the input may alternatively be directed to and detected by the television 360. For example, the user 304 or the second user 305 may provide the scrubbing input discussed above (or an alternative input) via a remote input device (e.g., a remote controller including a plurality of buttons and/or touch-sensitive surface(s)) in communication with the television 360.

In some examples, as shown in FIG. 3F, in response to detecting the input provided by the hand 303 above, the electronic device 101 updates the current playback position within the video content 315 in the virtual window 330. For example, as shown in FIG. 3F, the electronic device 101 rewinds the video content 315, which causes a different scene in the video content 315 to be displayed (e.g., different from the particular scene illustrated in FIG. 3E). As alluded to above, when the electronic device 101 updates the current playback position within the video content 315 in the virtual window 330 in response to detecting the input discussed above, the television 360 similarly updates the current playback position within the video content 315 that is displayed on the display 370 in the physical environment 340, as shown in FIG. 3F. For example, as shown in FIG. 3F, the television 360 rewinds the video content 315 such that the updated current playback position within the video content 315 that is displayed on the display 370 corresponds to (e.g., is the same as) the updated current playback position within the video content 315 that is displayed in the virtual window 330.

In some examples, in response to detecting the input for scrubbing through the video content 315, the electronic device 101 transmits a signal, a set of instructions, a command, or other data to the television 360 that causes and/or enables the television 360 to similarly respond to the input detected by the electronic device 101 (e.g., causes and/or enables the television 360 to similarly scrub through the video content 315). Alternatively, if the television 360 detects input for updating the current playback position within the video content 315, the television 360 transmits a signal, a set of instructions, a command, or other data to the electronic device 101 that causes and/or enables the electronic device 101 to similarly respond to the input detected by the television 360. As another example, the electronic device 101 may detect that the current playback position within the video content 315 has been updated and/or that playback of the video content 315 has been adjusted by visually detecting, via one or more cameras of the electronic device 101, the change in playback of the video content 315 on the display 370 in the physical environment 340. For example, the electronic device 101 determines, based on the captured images, that the television 360 is displaying a different scene in the video content 315, which causes the electronic device 101 to update the playback of the video content 315 similarly or accordingly.

It should be understood that alternative interactions with the devices that cause the playback of the video content 315 to be updated and/or adjusted are similarly maintained between the two devices (e.g., the electronic device 101 and the television 360). For example, if an input is received/detected by one of the devices (e.g., the electronic device 101 or the television 360) for pausing the video content 315, fast forwarding the video content 315, changing the video content 315 (e.g., initiating playback of a different content item), ceasing playback of the video content 315, etc., both devices (e.g., the electronic device 101 and the television 360) perform a particular operation in accordance with the input.

In FIG. 3G, while the electronic device 101 is displaying the virtual window 330 that includes the video content 315, the electronic device 101 detects movement of the viewpoint of the electronic device 101. In some examples, the movement of the viewpoint of the electronic device 101 is caused by movement of the user 304 of the electronic device 101. For example, as indicated in the overhead view 310, the user 304 (e.g., who is wearing the electronic device 101) moves (e.g., turns and walks) in the direction of arrow 371, which causes the viewpoint of the electronic device 101 to shift away from the television 360 in the physical environment 340. For example, as shown in FIG. 3H, when the viewpoint of the electronic device 101 is updated in accordance with the movement of the user 304, the television 360 (and thus the display 370 that is displaying the video content 315) is no longer visible in the current field of view of the electronic device 101. Rather, as shown in FIG. 3H, a different portion of the physical environment 340 is included in the three-dimensional environment 350 from the updated viewpoint, such as physical window 309 and left side wall of the physical environment 340.

In some examples, as shown in FIG. 3H, in response to detecting the movement of the viewpoint of the electronic device 101 that causes the display 370 of the television 360 to no longer be in the field of view of the electronic device 101, the electronic device 101 updates display of the virtual window 330 in the three-dimensional environment 350 in accordance with the movement of the viewpoint. For example, as shown in FIG. 3H, the electronic device 101 moves the virtual window 330 in the three-dimensional environment 350, such that the virtual window 330 is no longer displayed relative to the display 370 of the television 360 in the three-dimensional environment 350 (e.g., overlaid on and/or positioned in front of the television 360 in the three-dimensional environment 350). As shown in FIG. 3H, the electronic device 101 moves and/or redisplays the virtual window 330 based on the updated viewpoint of the electronic device 101. For example, the virtual window 330 is positioned relative to the viewpoint of the electronic device 101, optionally at a center of the field of view, in the three-dimensional environment 350. In some examples, the virtual window 330 is maintained at the same size in the three-dimensional environment 350 relative to the viewpoint of the user 304 in response to detecting the movement of the viewpoint. In some examples, the virtual window 330 is transitioned from being displayed as a world locked object in the three-dimensional environment 350 to being displayed as a head locked, body locked, or tilt locked object in the three-dimensional environment 350 in response to detecting the movement of the viewpoint.

In some examples, the movement of the viewpoint of the electronic device 101 causes the electronic device 101 to update display of the virtual window 330 in accordance with a determination that the movement of the viewpoint causes the electronic device 101 to be positioned greater than a threshold distance (e.g., 1, 2, 3, 5, 10, 15, 20, 30, etc. meters) from the display 370 of the television 360 in the physical environment 340. Accordingly, in the example of FIG. 3H, if the movement of the viewpoint of the electronic device 101 does not cause the display 370 of the television 360 to be outside of the current field of view of the electronic device 101 and/or does not cause the display 370 of the television 360 to be more than the threshold distance of the electronic device 101, the electronic device 101 forgoes updating display of the virtual window 330 in the three-dimensional environment 350. For example, the electronic device 101 maintains display of the virtual window 330 relative to the television 360 in the three-dimensional environment 350 (e.g., overlaid on and/or positioned in front of the display 370) and/or as a world locked object in the three-dimensional environment 350.

In some examples, when the electronic device 101 updates display of the virtual window 330 in response to detecting the movement of the viewpoint of the electronic device 101 discussed above, the electronic device 101 alternatively reduces the size of the virtual window 330 in the three-dimensional environment 350. For example, as shown in FIG. 3I, rather than maintaining the virtual window 330 at the same size when the viewpoint is updated, the electronic device 101 minimizes display of the virtual window 330, such that the video content 315 is displayed at a reduced size and/or with a reduced aspect ratio (e.g., as a picture-in-picture (Pipe) representation). Additionally, in some examples, as shown in FIG. 3I, the electronic device 101 moves the virtual window 330 to a different location on the display 120 (e.g., corresponding to a different location in the three-dimensional environment 350, as indicated in the overhead view 310). For example, as shown in FIG. 3I, the virtual window 330 is displayed at a corner (e.g., the bottom right corner) of the display 120 when the viewpoint of the electronic device 101 is updated (e.g., and the display 370 of the television 360 is no longer in the field of view of the electronic device 101).

Additionally, in some examples, when the display of the virtual window 330 is updated in the three-dimensional environment 350, the electronic device 101 may adjust one or more characteristics of the audio corresponding to the video content 315 that is being output by the electronic device 101. For example, as shown in FIG. 3I, the electronic device 101 may change (e.g., decrease) the volume 342 of the audio corresponding to the video content 315, as indicated by arrow 372 (e.g., or alternatively increase the volume 342 of the audio if the audio was previously not being outputted). As another example, the electronic device 101 may change the audio format of the audio corresponding to the video content 315. For example, the electronic device 101 may change the format from spatial audio to stereo audio (or vice versa) when the display of the virtual window 330 is updated in the three-dimensional environment 350. It should be understood that, in this instance, the display of the video content 315 and/or the one or more characteristics of the audio output by the electronic device 101 are adjusted without the display of the video content 315 and/or one or more characteristics of the audio corresponding to the video content 315 being adjusted at the television 360. As outlined above, minimizing display of the virtual window 330 and/or adjusting the one or more characteristics of the audio corresponding to the video content 315 when the viewpoint of the electronic device 101 changes enables awareness of the physical environment 340 to be preserved by the user, thereby maintaining user safety during use of the electronic device 101, as one benefit.

In some examples, the content displayed in the virtual window 330 when the viewpoint of the electronic device 101 is updated as discussed above may be changed to be different from the video content 315. For example, rather than displaying the video content 315 as a PiP representation, the video content 315 is replaced with supplemental content associated with the video content 315, such as the information discussed previously above with reference to the first user interface element 321, the second user interface element 322, and the third user interface element 323 in FIG. 3D. As an example, if the video content 315 corresponds to an athletic event (e.g., a soccer game), when the display of the virtual window 330 is updated as discussed above (e.g., displayed in a minimized state), the electronic device 101 replaces display of the video content 315 in the virtual window 330 with an indication of a current score of the soccer game and/or an indication of the game clock.

Additionally or alternatively, in some examples, the electronic device 101 selectively adjusts playback of the video content 315 in the three-dimensional environment 350 when the viewpoint of the electronic device 101 is updated in the manner discussed above. For example, as shown in FIG. 3J, the electronic device 101 (e.g., automatically) pauses playback of the video content 315 in the three-dimensional environment 350 (e.g., as indicated by play affordance 339) when the display of the virtual window 330 is updated in the three-dimensional environment 350. In such an instance, as similarly discussed previously above, playback of the video content 315 at the television 360 in the physical environment 340 would also be paused.

In some examples, the automatic pausing of the video content 315 in the three-dimensional environment 350 is based on the type of content of the video content 315. For example, it may be determined that it is desirable to automatically pause playback of certain types of content as opposed to others. In some examples, on-demand content items (e.g., movies, television shows, video clips, music videos, short films, etc.) may be automatically paused when the viewpoint of the electronic device 101 is updated in the manner discussed above, while live content items (e.g., content being broadcast or streamed live by their respective media providers, such as live athletic events, live performance events, live political debates, live news coverage, etc.) are not. In some examples, the pausing of the video content 315 may be performed in response to receiving user input confirming the pausing of the video content 315. For example, as shown in FIG. 3J, when the electronic device 101 displays the video content 315 in the minimized state on the display 120 in response to detecting the movement of the viewpoint of the electronic device 101 discussed above, the electronic device 101 transmits a request to the television 360 for pausing playback of the video content 315 (e.g., since playback of the video content 315 is synchronized between the two devices). As shown in FIG. 3J, in response to receiving the request from the electronic device 101, the television 360 displays message 311 on the display 370 (e.g., overlaid on the video content 315) prompting the second user 305 to provide confirmation of whether to pause playback of the video content 315 on the television 360, such as via selectable options 312 and 313, which also controls whether the electronic device 101 is able to pause playback of the video content 315 in the virtual window 330 in the three-dimensional environment 350. In some examples, as shown in FIG. 3J, in response to receiving a selection of selectable option 312 (e.g., via a remote input device in communication with the television 360), the television 360 pauses playback of the video content 315 on the display 370, which enables the electronic device 101 to pause playback of the video content 315, as indicated by the play affordance 339 (e.g., via data transmitted from the television 360 to the electronic device 101).

In some examples, in FIG. 3J, if the electronic device 101 detects an input directed to the play affordance 339 (e.g., an air pinch gesture while the gaze of the user 304 is directed to the play affordance 339), the electronic device 101 resumes playback of the video content 315, which also causes the television 360 to resume playback of the video content 315 on the display 370 in the physical environment 340 in a manner as similarly discussed above. Additionally, in some examples, if the electronic device 101 detects an input directed to the virtual window 330 in the three-dimensional environment 350, such as an air pinch gesture directed to the virtual window 330, a gaze dwell on the virtual window 330, a verbal command, etc., the electronic device 101 redisplays the virtual window 330 at its maximized size in the three-dimensional environment 350, such as illustrated in FIG. 3H, based on the updated viewpoint of the electronic device 101.

Attention is now directed toward example interactions causing virtual content displayed at an electronic device to be displayed on a physical display of a second electronic device, different from the electronic device, in a physical environment.

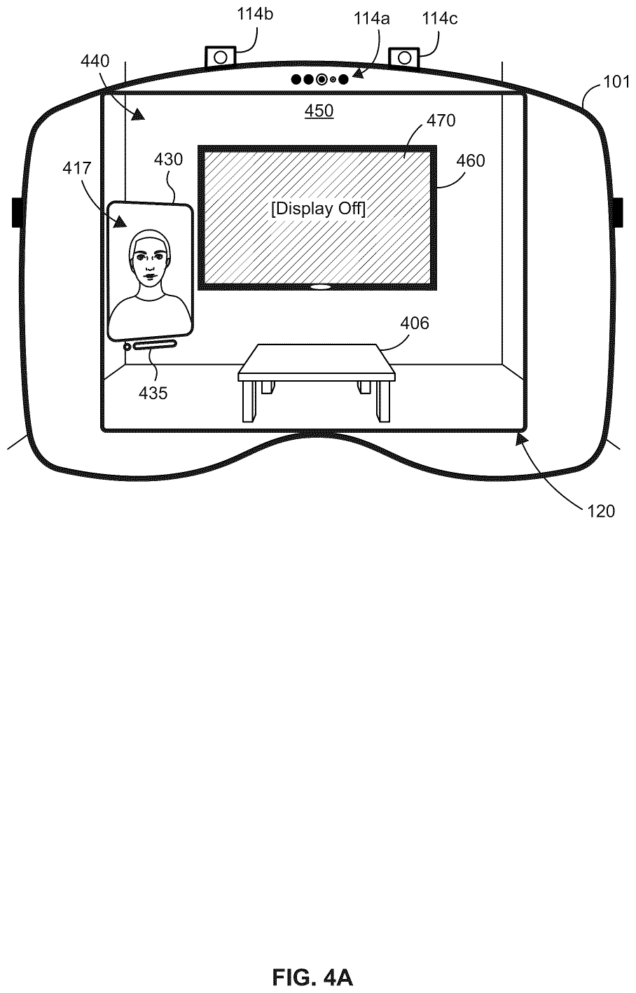

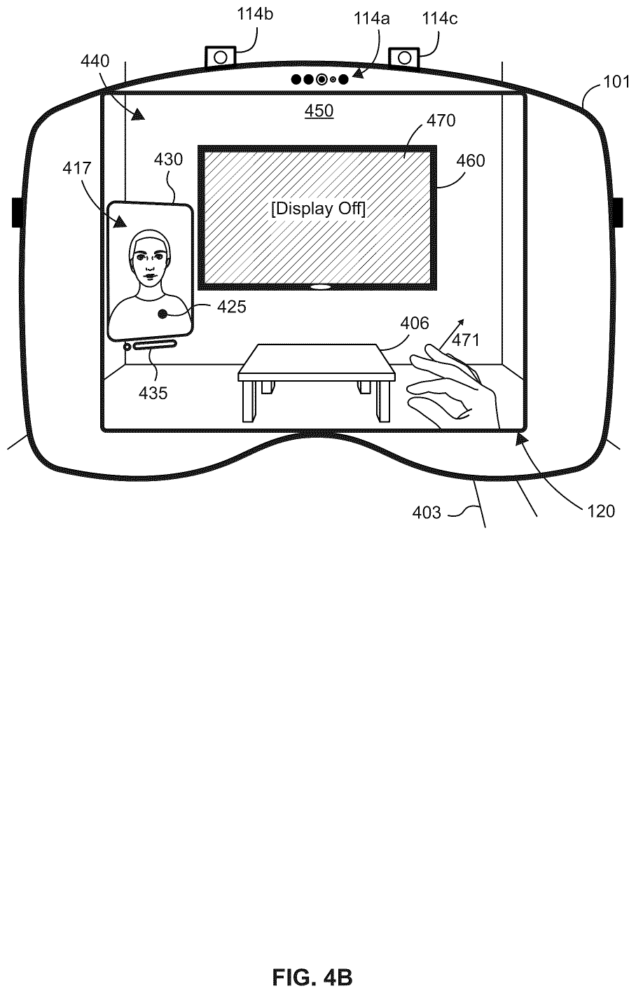

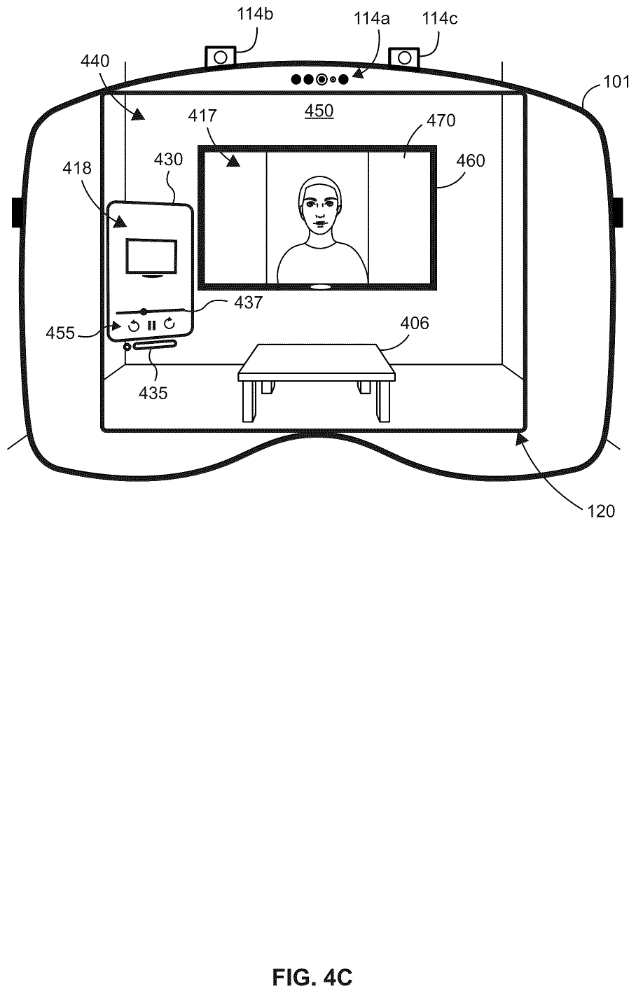

FIGS. 4A-4C illustrate examples of an electronic device causing display of content at a second electronic device in a physical environment according to some examples of the disclosure. The electronic device 101 may correspond to or may be similar to electronic device 101 or 201 discussed above. In the example of FIGS. 4A-4C, a user is optionally wearing the electronic device 101, such that three-dimensional environment 450 (e.g., a computer-generated environment) can be defined by X, Y and Z axes as viewed from a perspective of the electronic device (e.g., a viewpoint associated with the user of the electronic device 101). In some examples, the three-dimensional environment 450 has one or more characteristics of three-dimensional environment 350 discussed above. As shown in FIG. 4A, the electronic device 101 may be positioned in a physical environment 440 that includes a plurality of real-world objects, such as television 460 including display 470 and table 406. In some examples, the physical environment 440 has one or more characteristics of physical environment 340 discussed above. Additionally, in some examples, the television 460 has one or more characteristics of television 360 discussed above. In some examples, the electronic device 101 is configured to communicate with the television 460, as similarly discussed above. As indicated in FIG. 4A, the display 470 is currently inactive (e.g., is powered off, is in a sleep or low power mode), such that the display 470 is not currently displaying content.

As shown in FIG. 4A, the three-dimensional environment 450 optionally includes virtual window 430. In some examples, virtual window 430 has one or more characteristics of virtual window 330 described above. As shown in FIG. 4A, the virtual window 430 is optionally displayed with grabber bar 435 that is selectable to initiate movement of the virtual window 430 within the three-dimensional environment 450, as similarly discussed above. In some examples, as shown in FIG. 4A, the virtual window 430 includes user interface 417. For example, the user interface 417 is associated with an application running on the electronic device 101, such as a media player application, a web-browsing application, a photo library application, a video calling application, etc. Accordingly, in FIG. 4A, the electronic device 101 is displaying content (e.g., the user interface 417 in the virtual window 430) while the television 460 (e.g., or a secondary electronic device in communication with the television 460, such as a set-top box, console, cable box, etc., as similarly discussed above) is not.

In some examples, the electronic device 101 is configured to cause the television 460 (e.g., or a secondary electronic device in communication with the television 460) to initiate display of content that currently being displayed by the electronic device 101. In some examples, the electronic device 101 performs such an operation in response to detecting input provided by the user of the electronic device 101 corresponding to a request to cause the television 460 to display the content that is currently displayed by the electronic device 101, as discussed below.

In FIG. 4B, while the electronic device 101 is displaying the user interface 417 in the virtual window 430, the electronic device 101 detects an input provided by the user of the electronic device 101 corresponding to a request to cause the television 460 to display the user interface 417 on the display 470. In some examples, as shown in FIG. 4B, the input includes a hand gesture performed with hand 403 of the user. For example, in FIG. 4B, the electronic device 101 detects the user perform a pinch and drag gesture using the hand 403 while gaze 425 of the user is directed toward the user interface 417 and/or the virtual window 430 (e.g., but not toward the grabber bar 435). In some examples, the pinch and drag gesture includes movement of the hand 403 in space in a direction that is toward the display 470 of the television 460, as indicated by arrow 471. In some examples, the input includes an alternative gesture, such as a flinging gesture while the hand 403 is performing the pinch (e.g., mimicking a flinging (e.g., tossing or throwing) of a physical object toward the display 470 of the television 460). In some examples, the input includes a verbal command or selection of an affordance/option in a controls or settings user interface corresponding to a request to cause the television 460 to display the user interface 417 on the display 470 in the physical environment 440.

In some examples, as shown in FIG. 4C, in response to detecting the user input discussed above, the electronic device 101 causes the television 460 to display the user interface 417 on the display 470 in the physical environment 440. For example, as shown in FIG. 4C, the television 460 activates (e.g., powers on and/or awakens) the display 470 and displays the user interface 417 on the display 470. Additionally, as shown in FIG. 4C, the electronic device 101 optionally ceases display of the user interface 417 in the virtual window 430 in the three-dimensional environment 450. For example, as shown in FIG. 4C, the electronic device 101 replaces display of the user interface 417 with user interface 418, which optionally corresponds to a playback control user interface. As shown in FIG. 4C, the user interface 418 optionally includes a plurality of controls for controlling one or more aspects of the display of the user interface 417 on the display 470, such as playback timeline 437 and playback controls 455. Additionally, in some examples, as shown in FIG. 4C, the user interface 418 includes an indication that the content of the virtual window 430 is being displayed on the display 470 of the television 460. For example, as shown in FIG. 4C, the user interface 418 includes an icon, image, or other visual indication of a television.

In some examples, the television 460 (e.g., or a secondary electronic device in communication with the television 460) displays the user interface 417 on the display 470 based on data provided by the electronic device 101. For example, the electronic device 101 transmits metadata (e.g., image data, streaming data, etc.) to the television 460 (e.g., or a secondary electronic device in communication with the television 460) that enables the television 460 to display the user interface 417 on the display 470. In some examples, the television 460 displays the user interface 417 on the display 470 based on one or more indications of the content displayed by the electronic device 101 provided by the electronic device 101 that enable the television 460 to display the user interface 417. For example, the electronic device 101 transmits data including an indication of the specific content that is to be displayed (e.g., a name or other identifier associated with the user interface 417), a source or sources for the content (e.g., a location (e.g., applications) from which the user interface 417 can be accessed (e.g., streamed) for displaying the user interface 417), and/or an indication of how to display the content (e.g., a playback position, a playback speed, a particular portion of the user interface 417 to display, an aspect ratio for the user interface 417, etc.).

In some examples, when the television 460 displays the user interface 417 on the display 470, audio corresponding to the user interface 417 (e.g., if any) continues to be output by the electronic device 101 (e.g., via one or more speakers of the electronic device 101). Alternatively, in some examples, audio corresponding to the user interface 417 is no longer output by the electronic device 101 and is instead output by the television 460 (e.g., speakers integrated with the television 460 or a speaker system in communication with the television 460) in the physical environment 440. In some examples, the audio corresponding to the user interface 417 is output by both the electronic device 101 and the television 460 (e.g., in a synchronized fashion as previously discussed herein).

In some examples, while the television 460 is displaying the user interface 417 on the display 470, the display of the user interface 417 may also be controlled via user input received at the television 460. For example, user input detected via a remote input device (e.g., remote controller) in communication with the television 460 may also cause the television 460 to adjust display of (e.g., playback of, audio settings of, etc.) the user interface 417. Accordingly, while the user interface 417 is displayed on the display 470 of the television 460, the user interface 417 may be interacted with via input detected by the electronic device 101 (e.g., provided by the user of the electronic device 101) and via input detected by the television 460 (e.g., provided by a second user in the physical environment 440, similar to second user 305 discussed above). In some examples, the television 460 may cease display of the user interface 417 on the display 470 in response to detecting input provided on the remote input device (e.g., an input powering off the display 470 and/or the television 460) and/or in response to the electronic device 101 detecting input directed to the user interface 418 in the virtual window 430 (e.g., an input directed to an option/affordance for causing the television 460 to cease display of the user interface 417 on the display 470). In some such examples, when the television 460 ceases display of the user interface 417 on the display 470, the electronic device 101 may redisplay the user interface 417 in the virtual window 430 (e.g., as similarly shown in FIG. 4A) in the three-dimensional environment 450. Thus, as outlined above, causing a second electronic device, such as the television 460, to display content when the electronic device 101 detects user input corresponding to a request to display the content on the second electronic device enables a second user to view and thereby interact with the content in a shared viewing experience with the user of the electronic device 101 when the content is displayed on the second electronic device, as one benefit.

In some examples, the display of the user interface 417 on the display 470 of the television 460 is in accordance with a determination that one or more criteria are satisfied, such as one or more of the one or more criteria discussed above with reference to FIGS. 3A-3J. For example, the television 460 (e.g., or a secondary electronic device in communication with the television 460) displays the user interface 417 on the display 470 in the manner discussed above in accordance with a determination that the electronic device 101 is in communication with the television 460 (e.g., or the secondary electronic device), the user interface 417 is able to be displayed on the display 470 (e.g., based on device permissions, content accessibility, display compatibility, content type (e.g., three-dimensional versus two-dimensional content), etc.), the input provided by the user is indeed an input for causing the television 460 to display the user interface 417 on the display 470, and/or detectability of the display 470 of the television 460 (e.g., the display 470 being within the current field of view of the electronic device 101 and/or being within a threshold distance (e.g., 0.25, 0.5, 1, 2, 3, 5, 10, 15, etc. meters) of the electronic device 101), among other requirements. In some examples, if the one or more criteria are not satisfied, the television 460 forgoes displaying the user interface 417 on the display 470 in the physical environment 440. In some such examples, the electronic device 101 and/or the television 460 may provide a visual indication that the display of the user interface 417 on the display 470 was unsuccessful, such as via display of a notification or other message on the display 120 and/or the display 470. Additionally, the display 470 of the television 460 need not be off as shown in FIG. 4B when the input provided by the user is detected. For example, in such an instance, the television 460 replaces display of content being displayed on the display 470 with the user interface 417 as similarly shown in FIG. 4C.

It should be understood that though the exemplary interactions above are described specifically with reference to a television having a display (e.g., television 360/460), such interactions may be similarly and/or correspondingly applied to other electronic devices that have displays (e.g., integrated displays or non-integrated displays). For example, the interactions described above with respect to displaying content on the electronic device 101 and/or causing the television 460 to display content that is presented by the electronic device 101 may also be applied to desktop or laptop computers, tablets, smartphones, smart watches, and similar electronic devices having displays.

It is understood that the examples shown and described herein are merely exemplary and that additional and/or alternative elements may be provided within the three-dimensional environment relating to the synchronized display of content across multiple electronic devices. It should be understood that the appearance, shape, form and size of each of the various user interface elements and objects shown and described herein are exemplary and that alternative appearances, shapes, forms and/or sizes may be provided. For example, the virtual objects representative of user interfaces and/or windows (e.g., virtual window 330, and virtual window 430) may be provided in an alternative shape than a rectangular shape, such as a circular shape, oval shape, triangular shape, etc. Additionally or alternatively, in some examples, the various user interface elements described herein may be selected and/or manipulated via user input received via one or more separate input devices in communication with the electronic device(s). For example, where applicable, selection input (e.g., for initiating tracking of the exercise activity) may be received via physical input devices, such as a mouse, trackpad, keyboard, etc. in communication with the electronic device(s).

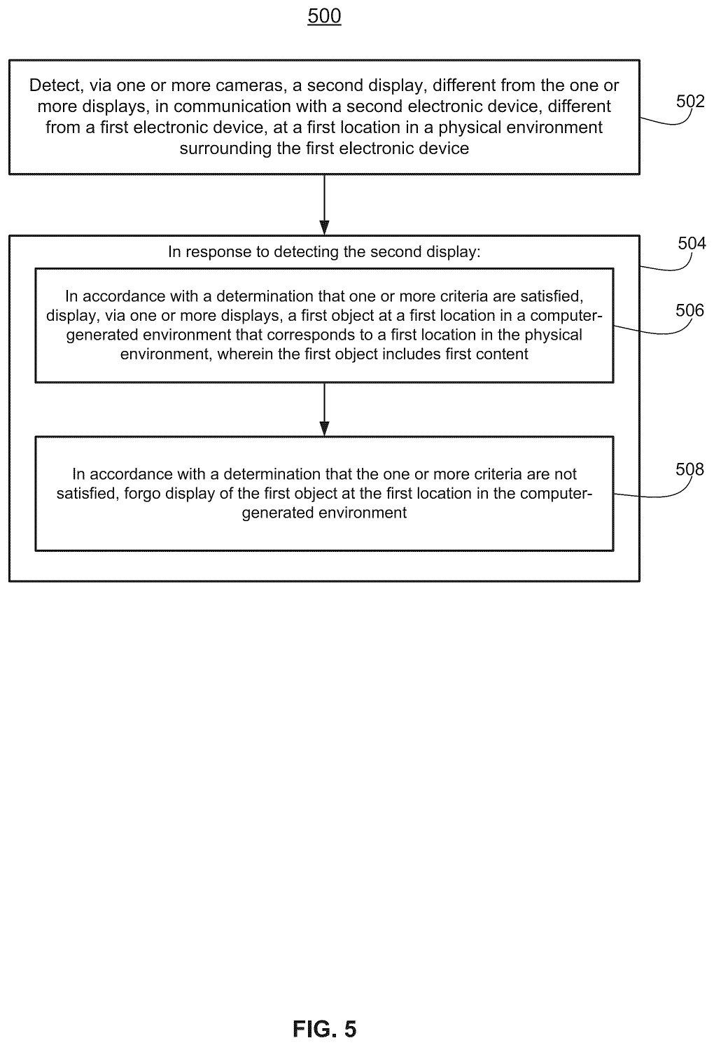

FIG. 5 is a flow diagram illustrating an example process for displaying a user interface including content in a computer-generated environment in response to detecting display of the content in a physical environment according to some examples of the disclosure. In some examples, process 500 begins at a first electronic device in communication with one or more displays, one or more input devices, and one or more cameras. In some examples, the electronic device is optionally a head-mounted display similar or corresponding to electronic device 201 of FIG. 2A and/or electronic device 101 of FIG. 1. As shown in FIG. 5, in some examples, at 502, the first electronic device detects, via the one or more cameras, a second display, different from the one or more displays, in communication with a second electronic device, different from the first electronic device, at a first location in a physical environment of (e.g., surrounding) the first electronic device. For example, as shown in FIG. 3B, electronic device 101 detects (e.g., via external image sensors 114b and 114c) display 370 of television 360 in physical environment 340. In some examples, the display 370 is displaying content, such as video content 315 shown in FIG. 3B.

In some examples, at 504, in response to detecting the second display, at 506, in accordance with a determination that one or more criteria are satisfied, the first electronic device displays, via the one or more displays, a first object at a first location in a computer-generated environment that corresponds to the first location in the physical environment, wherein the first object includes first content. For example, as shown in FIG. 3C, the electronic device 101 displays, via display 120, virtual window 330 that includes video content 315 in the three-dimensional environment 350. In some examples, as shown in the overhead view 310 in FIG. 3C, the electronic device 101 displays the virtual window 330 at a location relative to the display 370 of the television 360 in the three-dimensional environment 350, such as in front of and/or overlaid on the television 360 from a viewpoint of the electronic device 101. Satisfaction of the one or more criteria is discussed in detail with reference to FIG. 3B above.

In some examples, at 508, in accordance with a determination that the one or more criteria are not satisfied, the first electronic device forgoes display of the first object at the first location in the computer-generated environment. For example, as show in FIG. 3A, the electronic device 101 forgoes display of the virtual window 330 that includes the video content 315 in the three-dimensional environment 350.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIGS. 2A-2B) or application specific chips, and/or by other components of FIG. 2A-2B.

Therefore, according to the above, some examples of the disclosure are directed to a method, comprising at a first electronic device in communication with one or more displays, one or more input devices, and one or more cameras: detecting, via the one or more cameras, a second display, different from the one or more displays, in communication with a second electronic device, different from the first electronic device, at a first location in a physical environment of the first electronic device; and in response to detecting the second display, in accordance with a determination that one or more criteria are satisfied, displaying, via the one or more displays, a first object at a first location in a computer-generated environment that corresponds to the first location in the physical environment, wherein the first object includes first content, and in accordance with a determination that the one or more criteria are not satisfied, forgoing display of the first object at the first location in the computer-generated environment.

Additionally or alternatively, in some examples, the one or more criteria include a criterion that is satisfied in accordance with a determination that the second display is displaying the first content. Additionally or alternatively, in some examples, the one or more criteria include a criterion that is satisfied in accordance with a determination that the first content is content of a first type and that is not satisfied in accordance with a determination that the first content is content of a second type, different from the first type. Additionally or alternatively, in some examples, the one or more criteria include a criterion that is satisfied in accordance with a determination that gaze of a user of the first electronic device is directed to the second display when the second display is detected. Additionally or alternatively, in some examples, the one or more criteria include a criterion that is satisfied in accordance with a determination that, based on one or more physical properties of the second display, content displayed via the second display is visually detectable via the one or more cameras. Additionally or alternatively, in some examples, while the first object is displayed at the first location in the computer-generated environment in accordance with the determination that the one or more criteria are satisfied in response to detecting the second display, the first object visually occludes the second display from a viewpoint of a user of the first electronic device. Additionally or alternatively, in some examples, the first content corresponds to two-dimensional content. Additionally or alternatively, in some examples, the first object corresponds to a virtual application window displaying the first content.

Additionally or alternatively, in some examples, displaying the first object that includes the first content includes identifying, in one or more images of the second display captured via the one or more cameras, one or more features of the first content, and obtaining, based on the identification of the one or more features of the first content, the first content for display in the first object in the computer-generated environment. Additionally or alternatively, in some examples, obtaining the first content is in accordance with a determination that a user of the first electronic device has authorization to access the first content via the first electronic device. Additionally or alternatively, in some examples, the first electronic device is in communication with the second electronic device, and the first electronic device obtains the first content based on data provided by the second electronic device. Additionally or alternatively, in some examples, the first electronic device is in communication with the second electronic device, and the first electronic device obtains and displays the first content based on image data provided by the second electronic device. Additionally or alternatively, in some examples, the one or more criteria include a criterion that is satisfied in accordance with a determination that the second display is displaying the first content, displaying the first content in the first object includes presenting audio corresponding to the first content, and in accordance with the determination that the one or more criteria are satisfied, presentation of the audio corresponding to the first content is synchronized between the first electronic device and the second electronic device. Additionally or alternatively, in some examples, the first content corresponds to first video content, the one or more criteria include a criterion that is satisfied in accordance with a determination that the second display is displaying the first video content, and in accordance with the determination that the one or more criteria are satisfied, playback of the first video content is synchronized between the first electronic device and the second electronic device.

Additionally or alternatively, in some examples, the method further comprises: while displaying the first video content in the first object in the computer-generated environment in accordance with the determination that the one or more criteria are satisfied in response to detecting the second display, detecting an indication of a request to scrub through the first video content; and in response to detecting the indication, updating a current playback position within the first video content in the first object in accordance with the request, wherein the second electronic device updates the current playback position within the first video content on the second display in accordance with the request. Additionally or alternatively, in some examples, the method further comprises: while displaying the first content in the first object in the computer-generated environment in accordance with the determination that the one or more criteria are satisfied in response to detecting the second display, detecting, via the one or more input devices, movement of the first electronic device; and in response to detecting the movement of the first electronic device, in accordance with a determination that the movement of the first electronic device causes the second display to no longer be detectable via the one or more cameras, displaying, via the one or more displays, the first object at a second location, different from the first location, in the computer-generated environment. Additionally or alternatively, in some examples, the second location in the computer-generated environment is determined based on an updated viewpoint of a user of the first electronic device in accordance with the movement of the first electronic device. Additionally or alternatively, in some examples, the method further comprises: while displaying the first content in the first object in the computer-generated environment in accordance with the determination that the one or more criteria are satisfied in response to detecting the second display, detecting, via the one or more input devices, movement of the first electronic device; and in response to detecting the movement of the first electronic device, in accordance with a determination that the movement of the first electronic device causes the second display to no longer be detectable via the one or more cameras, replacing display, via the one or more displays, of the first object with a second object in the computer-generated environment, wherein the second object includes second content that is associated with the first content. Additionally or alternatively, in some examples, the second content in the second object corresponds to a picture-in-picture representation of the first content in the first object, and the second object is displayed with a head-locked orientation in the computer-generated environment.

Additionally or alternatively, in some examples, displaying the first content in the first object includes presenting audio corresponding to the first content at a first volume, and displaying the second content in the second object includes presenting the audio corresponding to the first content at a second volume, lower than the first volume. Additionally or alternatively, in some examples, displaying the first content in the first object includes presenting audio corresponding to the first content in a first audio format, and displaying the second content in the second object includes presenting the audio corresponding to the first content in a second audio format, different from the first audio format. Additionally or alternatively, in some examples, the method further comprises: while displaying the first content in the first object in the computer-generated environment in accordance with the determination that the one or more criteria are satisfied in response to detecting the second display, detecting, via the one or more input devices, movement of the first electronic device; and in response to detecting the movement of the first electronic device, in accordance with a determination that the movement of the first electronic device causes the second display to no longer be detectable via the one or more cameras, ceasing display of the first object in the computer-generated environment, and presenting audio corresponding to the first content. Additionally or alternatively, in some examples, the method further comprises: while displaying the first content in the first object in the computer-generated environment in accordance with the determination that the one or more criteria are satisfied in response to detecting the second display, detecting, via the one or more input devices, movement of the first electronic device that causes the second display to no longer be detectable via the one or more cameras; and in response to detecting the movement of the first electronic device, in accordance with a determination that the first content is content of a first type, replacing display, via the one or more displays, of the first object with a second object in the computer-generated environment, wherein the second object includes second content that is associated with the first content, and in accordance with a determination that the first content is content of a second type, different from the first type, pausing playback of the first content in the first object in the computer-generated environment. Additionally or alternatively, in some examples, the second display is not displaying content, the method further comprising: while displaying, via the one or more displays, a second object that includes second content in the computer-generated environment, detecting, via the one or more input devices, a respective gesture performed by a hand of a user of the first electronic device directed to the second display; and in response to detecting the respective gesture, causing the second electronic device to display, via the second display, the second content. Additionally or alternatively, in some examples, causing the second electronic device to display the second content includes transmitting, to the second electronic device, data including instructions enabling the second electronic device to generate and display the second content on the second display. Additionally or alternatively, in some examples, the first electronic device includes a head-mounted display, and the second electronic device corresponds to a computing device.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays, one or more input devices, and one or more cameras:
detecting, via the one or more cameras, a second display, different from the one or more displays, in communication with a second electronic device, different from the first electronic device, at a first location in a physical environment of the first electronic device; and
in response to detecting the second display:
in accordance with a determination that one or more criteria are satisfied, displaying, via the one or more displays, a first object at a first location in a three-dimensional environment that corresponds to the first location in the physical environment, wherein the first object includes first content; and
in accordance with a determination that the one or more criteria are not satisfied, forgoing display of the first object at the first location in the three-dimensional environment.

2. The method of claim 1, wherein the one or more criteria include a criterion that is satisfied in accordance with a determination that the second display is displaying the first content.

3. The method of claim 1, wherein the one or more criteria include a criterion that is satisfied in accordance with a determination that the first content is content of a first type and that is not satisfied in accordance with a determination that the first content is content of a second type, different from the first type.

4. The method of claim 1, wherein the one or more criteria include a criterion that is satisfied in accordance with a determination that gaze of a user of the first electronic device is directed to the second display when the second display is detected.

5. The method of claim 1, wherein the one or more criteria include a criterion that is satisfied in accordance with a determination that, based on one or more physical properties of the second display, content displayed via the second display is visually detectable via the one or more cameras.

6. The method of claim 1, wherein, while the first object is displayed at the first location in the three-dimensional environment in accordance with the determination that the one or more criteria are satisfied in response to detecting the second display, the first object visually occludes the second display from a viewpoint of a user of the first electronic device.

7. The method of claim 1, wherein displaying the first object that includes the first content includes:
identifying, in one or more images of the second display captured via the one or more cameras, one or more features of the first content; and
obtaining, based on the identification of the one or more features of the first content, the first content for display in the first object in the three-dimensional environment.

8. The method of claim 1, wherein:
the one or more criteria include a criterion that is satisfied in accordance with a determination that the second display is displaying the first content;
displaying the first content in the first object includes presenting audio corresponding to the first content; and
in accordance with the determination that the one or more criteria are satisfied, playback of the first content and presentation of the audio corresponding to the first content are synchronized between the first electronic device and the second electronic device.

9. A first electronic device comprising:
one or more processors;
memory; and
one or more programs stored in the memory and configured to be executed by the one or more processors, the one or more programs including instructions for performing a method comprising:
detecting, via one or more cameras, a second display, different from one or more displays of the first electronic device, in communication with a second electronic device, different from the first electronic device, at a first location in a physical environment of the first electronic device; and
in response to detecting the second display:
in accordance with a determination that one or more criteria are satisfied, displaying, via the one or more displays, a first object at a first location in a three-dimensional environment that corresponds to the first location in the physical environment, wherein the first object includes first content; and
in accordance with a determination that the one or more criteria are not satisfied, forgoing display of the first object at the first location in the three-dimensional environment.

10. The first electronic device of claim 9, wherein the one or more criteria include a criterion that is satisfied in accordance with a determination that the second display is displaying the first content.

11. The first electronic device of claim 9, wherein the one or more criteria include a criterion that is satisfied in accordance with a determination that the first content is content of a first type and that is not satisfied in accordance with a determination that the first content is content of a second type, different from the first type.

12. The first electronic device of claim 9, wherein the one or more criteria include a criterion that is satisfied in accordance with a determination that gaze of a user of the first electronic device is directed to the second display when the second display is detected.

13. The first electronic device of claim 9, wherein the one or more criteria include a criterion that is satisfied in accordance with a determination that, based on one or more physical properties of the second display, content displayed via the second display is visually detectable via the one or more cameras.

14. The first electronic device of claim 9, wherein, while the first object is displayed at the first location in the three-dimensional environment in accordance with the determination that the one or more criteria are satisfied in response to detecting the second display, the first object visually occludes the second display from a viewpoint of a user of the first electronic device.

15. The first electronic device of claim 9, wherein displaying the first object that includes the first content includes:
identifying, in one or more images of the second display captured via the one or more cameras, one or more features of the first content; and
obtaining, based on the identification of the one or more features of the first content, the first content for display in the first object in the three-dimensional environment.

16. The first electronic device of claim 9, wherein:
the one or more criteria include a criterion that is satisfied in accordance with a determination that the second display is displaying the first content;
displaying the first content in the first object includes presenting audio corresponding to the first content; and
in accordance with the determination that the one or more criteria are satisfied, playback of the first content and presentation of the audio corresponding to the first content are synchronized between the first electronic device and the second electronic device.

17. A non-transitory computer readable storage medium storing one or more programs, the one or more programs comprising instructions, which when executed by one or more processors of a first electronic device, cause the first electronic device to perform a method comprising:
detecting, via one or more cameras, a second display, different from one or more displays of the first electronic device, in communication with a second electronic device, different from the first electronic device, at a first location in a physical environment of the first electronic device; and
in response to detecting the second display:
in accordance with a determination that one or more criteria are satisfied, displaying, via the one or more displays, a first object at a first location in a three-dimensional environment that corresponds to the first location in the physical environment, wherein the first object includes first content; and
in accordance with a determination that the one or more criteria are not satisfied, forgoing display of the first object at the first location in the three-dimensional environment.

18. The non-transitory computer readable storage medium of claim 17, wherein the one or more criteria include a criterion that is satisfied in accordance with a determination that the second display is displaying the first content.

19. The non-transitory computer readable storage medium of claim 17, wherein the one or more criteria include a criterion that is satisfied in accordance with a determination that the first content is content of a first type and that is not satisfied in accordance with a determination that the first content is content of a second type, different from the first type.

20. The non-transitory computer readable storage medium of claim 17, wherein the one or more criteria include a criterion that is satisfied in accordance with a determination that gaze of a user of the first electronic device is directed to the second display when the second display is detected.

21. The non-transitory computer readable storage medium of claim 17, wherein the one or more criteria include a criterion that is satisfied in accordance with a determination that, based on one or more physical properties of the second display, content displayed via the second display is visually detectable via the one or more cameras.

22. The non-transitory computer readable storage medium of claim 17, wherein, while the first object is displayed at the first location in the three-dimensional environment in accordance with the determination that the one or more criteria are satisfied in response to detecting the second display, the first object visually occludes the second display from a viewpoint of a user of the first electronic device.

23. The non-transitory computer readable storage medium of claim 17, wherein displaying the first object that includes the first content includes:
identifying, in one or more images of the second display captured via the one or more cameras, one or more features of the first content; and
obtaining, based on the identification of the one or more features of the first content, the first content for display in the first object in the three-dimensional environment.

24. The non-transitory computer readable storage medium of claim 17, wherein:
the one or more criteria include a criterion that is satisfied in accordance with a determination that the second display is displaying the first content;
displaying the first content in the first object includes presenting audio corresponding to the first content; and
in accordance with the determination that the one or more criteria are satisfied, playback of the first content and presentation of the audio corresponding to the first content are synchronized between the first electronic device and the second electronic device.
